(19) United States
(12) Patent Application Publication
(10) Pub. No.: US 2025/0199295 A1
(43) Pub. Date: Jun. 19, 2025

(54) LENS UNIT, CAMERA MODULE, IN-VEHICLE SYSTEM, AND MOBILE BODY

(71) Applicant: MAXELL, LTD., Kyoto (JP)

(72) Inventors: Yusuke BABA, Kyoto (JP); Takayuki SUGINOME, Kyoto (JP); Koshi FUJII, Kyoto (JP); Masatoshi SHIBATA, Kyoto (JP)

(21) Appl. No.: 18/845,466

(22) PCT Filed: Feb. 22, 2023
(86) PCT No.: PCT/JP2023/006570

§ 371 Date: Sep. 10, 2024

(30) Foreign Application Priority Data
Mar. 11, 2022 (JP) 2022-037935

(51) Int. Cl. G02B 27/00; G02B 7/02

(52) U.S. Cl. CPC G02B 27/0006; G02B 7/02

(57) ABSTRACT

Provided are a lens unit, a camera module, an in-vehicle system, and a mobile body capable of maintaining sealability in an inter-lens space, effectively suppressing entry of water vapor into the inter-lens space, and preventing dew condensation on a lens surface. The lens unit includes a seal portion for preventing water vapor from entering the inter-lens space, and the seal portion forms a two-stage seal including an object-side sealing material that seals a gas flow path toward the inter-lens space so as to block the gas flow path on the object side and an image-side sealing material that seals a gas flow path toward the inter-lens space so as to block the gas flow path on the image side.

### TECHNICAL FIELD

The present invention particularly relates to a lens unit constituting an in-vehicle camera mounted on a vehicle such as an automobile, a camera module, an imaging system, and a mobile body equipped with an in-vehicle system.

### BACKGROUND ART

Conventionally, an in-vehicle camera is mounted on an automobile to support parking and prevent collision by image recognition, and further, attempts have been made to apply this to automatic driving. Furthermore, such a camera module of an in-vehicle camera or the like generally includes a lens unit having a lens group formed by arranging a plurality of lenses along an optical axis, a lens barrel (barrel) accommodating and holding the lens group, and a diaphragm member disposed between lenses of at least one part of the lens group (see, for example, Patent Literature 1).

In particular, in a case where at least a part of a lens unit for an in-vehicle camera is installed outside the vehicle, for waterproof and dust-proof purposes, like a lens unit 500 illustrated in FIG. 11, for example, an O-ring 140 is interposed as a seal member between a first lens 100 located closest to the object side of a lens group L and a lens barrel 120 in a state where the lens group L is incorporated, accommodated, and held in the inner accommodation space S of the lens barrel 120, so that water and dust do not enter the lens group L inside the lens barrel 120. In this case, an outer peripheral side surface 100a of the first lens 100 is provided with a stepped diameter-reduced portion 100b whose diameter is reduced in the image-side portion of the lens 100, the O-ring 140 is attached to the diameter-reduced portion 100b, and the O-ring 140 is compressed, for example, in the radial direction between the outer peripheral side surface 100a of the first lens 100 and the inner peripheral surface 120a of the lens barrel 120, whereby the object-side end of the lens barrel 120 is sealed.

Furthermore, if the lens barrel 120 is made of resin, for example, as illustrated in FIG. 11, it is general that the lens barrel 120 has a caulking portion 123 at an end on the object side (an upper end in FIG. 11). In this case, the first lens 100 is fixed to the end on the object side of the lens barrel 120 by the caulking portion 123 by caulking the caulking portion 123 radially inward in a state where the lens group L is incorporated, accommodated, and held in the inner accommodation space S of the lens barrel.

### CITATION LIST

### Patent Literature

Patent Literature 1: JP 2013-231993 A

### SUMMARY OF INVENTION

### Technical Problem

By the way, even if the waterproof measure is performed by the O-ring 140 as described above, moisture (water vapor) may enter the lens unit 500 through various paths. Therefore, when the difference between the outside air temperature and the temperature in the lens unit 500 increases, the water vapor in the lens unit 500 condenses and dew condensation occurs on the lens surface. In particular, dew condensation is likely to occur in an inter-lens space S1 between the first lens 100 having the largest influence of the temperature difference with the outside and a second lens 101 adjacent thereto, particularly on a back surface 100c of the first lens 100.

The reason why the difference between the outside air temperature and the temperature in the lens unit 500 increases is that the temperature in the lens unit 500 increases in winter when the outside air is cold, specifically, for example, the temperature in the lens unit 500 increases due to heat transmitted from a normally energized image sensor (imaging element) 520 for receiving light condensed through the lens unit 500 and converting the light into an electric signal, or a surface 100d of the first lens 100 exposed to the outside in a state where the temperature in the lens unit 500 is high due to heat from the image sensor 520 and a surrounding environment (for example, an engine of a vehicle) is exposed to the outside air or rain, or the first lens 100 is cooled by receiving water spray of a water pool on a road surface.

Furthermore, examples of the path that allows the water vapor to enter the lens unit 500 include a path from the gap between the caulking portion 123 of the lens barrel 120 and the first lens 100 to a part of the periphery of the O-ring 140 and the inter-lens space S1 or the like through the gap between the first lens 100 and the lens barrel 120 and/or the second lens 101, a path directly passing through the moisture-permeable resin of the lens barrel 120, a path sequentially passing through the lens barrel 120 and the moisture-permeable resin forming the lens, and the like. In particular, moisture of the substrate 522 supporting the sensor 520 is evaporated by heat generated by the image sensor 520, and the water vapor enters the lens unit 500, so that the water vapor finally enters the inter-lens space S1.

In any case, when the water vapor gradually enters the inside of the lens unit 500 through such a path and a temperature difference occurs between the outside air and the inside of the lens unit 500 due to the above-described factors, dew condensation occurs in the inter-lens space S1, particularly on the back surface 100c of the first lens 100, and the captured image is blurred, so that a desired resolution cannot be obtained (visibility is deteriorated). Therefore, it is required to further secure airtightness of the lens unit 500 and to suppress entry of water vapor into the inter-lens space S1.

Therefore, conventionally, for example, as illustrated in FIG. 11, an adhesive 125 is interposed between the surfaces of the first and second lenses 100 and 101 facing each other, that is, between a seat surface (flange) 100e facing the image side of the first lens 100 and a seat surface (flange) 101a facing the object side of the second lens 101, and the lenses 100 and 101 are adhered to each other in an airtight state by the adhesive 125, so that the inter-lens space S1 between the first lens 100 and the second lens 101 is sealed to the outside.

However, since the adhesive 125 has a certain degree of moisture permeability, water vapor gradually enters the inter-lens space S1 through the adhesive 125, and eventually, dew condensation occurs on the back surface 100c of the first lens 100, and a captured image is blurred, which may deteriorate visibility.

The present invention has been made in view of the above circumstances, and an object of the present invention is to provide a lens unit, a camera module, an in-vehicle system, and a mobile body capable of maintaining sealability in an inter-lens space, effectively suppressing entry of water vapor into the inter-lens space, and preventing dew condensation on a lens surface.

### Solution to Problem

In order to solve the above problems, the present invention provides a lens unit including an optical element having at least a lens group formed by arranging a plurality of lenses along an optical axis and a lens barrel having an inner accommodation space accommodating and holding the optical element, the lens group including a first lens located closest to an object side and a second lens adjacent to the first lens on an image side, and an inter-lens space being formed between the first lens and the second lens, the lens unit including a seal portion that prevents entry of water vapor into the inter-lens space, wherein the seal portion forms a two-stage seal including an object-side sealing material that seals a gas flow path toward the inter-lens space so as to block the gas flow path on an object side, and an image-side sealing material that seals a gas flow path toward the inter-lens space so as to block the gas flow path on an image side.

According to the above configuration of the present invention, since the water vapor is prevented from entering the inter-lens space by the two-stage seal including the object-side sealing material that seals the gas flow path toward the inter-lens space so as to block the gas flow path on the object side and the image-side sealing material that seals the gas flow path toward the inter-lens space so as to block the gas flow path on the image side, it is possible to effectively avoid a situation in which the water vapor from the image side, particularly, the water vapor generated in the mounting substrate of the image sensor that receives the light collected through the lens unit on the image side and converts the light into an electric signal and taken into the inner accommodation space enters the inter-lens space to cause dew condensation on the back surface of the first lens. Therefore, it is possible to avoid a situation in which the captured image is blurred and desired resolution cannot be obtained (visibility is deteriorated). Furthermore, if the object-side sealing material of the seal portion further includes an O-ring interposed between the first lens and the lens barrel, water vapor from the object side can also be prevented from entering the inter-lens space, which is advantageous.

In addition, such a water vapor shielding effect by the two-stage seal is particularly advantageous in a lens unit at least partially accompanied by a lens incorporation form in which the lens constituting the lens group is in point contact with the lens barrel in the circumferential direction in a cross section perpendicular to the optical axis direction, thereby forming a gap with the inner surface of the lens barrel in the radial direction. In such a lens incorporation form, since the gas flow path forms the communication path formed by each gap between each lens constituting the lens group and the inner surface of the lens barrel and continuously extending along the optical axis direction, the water vapor from the image side easily enters the inter-lens space. Therefore, it is possible to reliably prevent the water vapor from entering the inter-lens space and effectively avoid a situation in which dew condensation occurs on the back surface of the first lens by blocking such a communication path by the two-stage seal.

In the above configuration, the image-side sealing material is located closer to the image side than the object-side sealing material in the direction along the optical axis. In this case, in order to effectively regulate the entry of water vapor into the final inter-lens space, it is preferable that the object-side sealing material is provided adjacent to the inter-lens space, and in order to regulate the entry of water vapor from the mounting substrate of the image sensor described above into the lens unit, it is preferable that the image-side sealing material is provided near the image-side end of the lens unit. In the above configuration, both the object-side sealing material and the image-side sealing material may be provided on the image side of the inter-lens space. Examples of the object-side sealing material and the image-side sealing material include an adhesive medium such as an adhesive, an O-ring, a moisture absorber (water absorber), and an airtight material. In the above configuration, the “optical element” includes all elements involved in the optical system in the lens barrel including the intermediate spacer, the intermediate ring, the infrared cut filter, and the like interposed between the lenses as well as the lenses constituting the lens group.

Further, in the above configuration, it is preferable that the object-side sealing material of the seal portion includes an adhesive layer that adheres annular seat surfaces of the first lens and the second lens facing each other in the optical axis direction in an airtight state so that the inside of the inter-lens space is sealed to an outside thereof, and the image-side sealing material of the seal portion includes an adhesive, an O-ring, or a water absorber interposed between the optical element and the lens barrel. Accordingly, since the first lens and the second lens are bonded to each other in an airtight state by the adhesive layer so that the inside of the inter-lens space is sealed to the outside thereof, even in a high humidity environment, the entry of water vapor into the inter-lens space where dew condensation is most likely to occur is suppressed immediately before, and furthermore, the entry of water vapor from the image side into the inter-lens space is further suppressed by the image-side sealing material (airtightness is improved), so that the amount of water vapor in the inter-lens space can be reduced, and the occurrence of dew condensation on the lens surface, particularly, dew condensation on the image-side surface (back surface) of the first lens can be suppressed.

Here, as the adhesive layer of the object-side sealing material, it is preferable to use a low moisture permeability (for example, a water vapor transmission rate of 60 g/m²·24 hr or less) adhesive having low olefinic or acrylic hardness, and the thickness of the adhesive layer is preferably 5 to 20 μm. On the other hand, when an adhesive is used as the image-side sealing material, such an adhesive is particularly preferably an olefin-based low moisture permeability (for example, a water vapor transmission rate of 60 g/m²·24 hr or less) adhesive (for example, a UV curable adhesive), and in particular, it is preferable to use a colored adhesive other than transparent (for example, white, black, milky white close to gray, and the like). This is because when the adhesive is transparent, light may be reflected to cause a ghost phenomenon. In addition, the thickness of the adhesive of the image-side sealing material is preferably 5 to 1000 μm, and in this case, the adhesive may be filled in a gap (gas flow path) between the optical element and the lens barrel, or may be filled in an adhesive storage space formed by processing an outer surface of the optical element or an inner surface of the lens barrel.

In addition, when an optical element other than the lens, for example, an intermediate ring or an intermediate spacer is used as an optical element that interposes the image-side sealing material between the lens barrel and the image-side sealing material, it is advantageous that the optical characteristics are not affected since it is not necessary to process the lens in order to interpose the image-side sealing material. In addition, when the O-ring is used as the image-side sealing material, mountability to the optical element and mountability to the lens unit are improved.

When a water absorber (moisture absorber) is used as the image-side sealing material, the thickness of the water absorber is preferably 0.1 to 100 μm. When the thickness dimension of the water absorber is smaller than 0.1 μm, the water absorption rate becomes insufficient, and on the other hand, when the thickness dimension of the water absorber is larger than 100 μm, the light transmittance decreases, and desired optical performance cannot be obtained. Examples of the material of the water absorber that can satisfy a desired water absorption rate and light transmittance include polyacrylate, starch-acrylate graft polymer, vinyl acetate copolymer, polyvinyl alcohol-based polymer, carboxymethyl cellulose-based polymer, hydroxypropyl cellulose, polyvinyl alcohol, polyvinyl pyrrolidone, polyvinyl acetal, polyvinyl acetate, silica gel, zeolite, and activated carbon.

In the above configuration, the optical element that interposes the image-side sealing material with the lens barrel may be a lens that constitutes the lens group and is located closest to the image side. As described above, when the image-side sealing material is provided between the lens barrel and the lens at the image-side end where the entry of water vapor into the lens unit is most concerned among paths that can allow the entry of water vapor into the lens unit, water vapor toward the inter-lens space can be cut off from the root by the generation source, so that the entire inside of the inner accommodation space of the lens barrel can be maintained in a low humidity state, and an excellent lens antifogging effect can be achieved for all the lenses constituting the lens group. In this case, when the image-side sealing material is an O-ring, such an O-ring is preferably made of, for example, butyl rubber having low gas permeability. Also in this case, the O-ring is preferably colored for the reason described above in order to prevent the occurrence of the ghost phenomenon. In addition, such an image-side end sealing configuration is particularly advantageous in a case of a lens unit structure in which water vapor easily enters from the image side, for example, in a case where a lens located closest to the image side is a meniscus lens which is easily deformed in an environment where temperature changes drastically in a state where the image-side end of the lens barrel is not sealed, and thus the lens is loosely fitted to the inner surface of the lens barrel with a predetermined gap.

In the above configuration, the optical element that interposes the image-side sealing material with the lens barrel may be a blocking body that is bonded to the image-side end of the lens barrel to seal the inside of the inner accommodation space to the outside on the image side. Examples of such a blocking body include an infrared cut filter, a bandpass filter, a cover glass, and the like, but are not limited thereto. When the blocking body is bonded and fixed to the lens barrel with an adhesive, examples of such an adhesive include an ultraviolet curable adhesive, a thermosetting adhesive, and a moisture curable adhesive, but are not limited thereto. In addition, such an adhesive may form the image-side sealing material. In addition, a water absorber may be provided on the front surface (or back surface) of the blocking body as the image-side sealing material, and in this case, the water absorber may be provided on the blocking body in any form. For example, the water absorber may be a film that is formed on the surface of the blocking body and has a water absorption rate of 10% or more. Such a film body is formed by, for example, a film forming method such as dip coating, spin coating, or die coating. In addition, it is preferable that the water absorber material has a light shielding property and is annularly provided outside the effective diameter of the lens group. Accordingly, the water absorber does not affect the optical performance of the lens unit, and an effect of suppressing ghost and flare can be obtained due to the light shielding property of the water absorber. When such an annular water absorber having an outer effective diameter is obtained by film formation, such film formation can be easily realized, for example, by defining a film formation range with a mask or the like.

In addition, the present invention also provides a camera module having the above-described lens unit, an in-vehicle system having the camera module, and a mobile body on which the in-vehicle system is mounted. With such a camera module, an in-vehicle system, and a mobile body, it is possible to obtain the same operation and effect as those of the lens unit described above. Furthermore, the “mobile body” refers to all objects that can move, and examples thereof include vehicles and the like.

### Advantageous Effects of Invention

According to the present invention, since the water vapor is prevented from entering the inter-lens space by the two-stage seal including the object-side sealing material that seals the gas flow path toward the inter-lens space so as to block the gas flow path on the object side and the image-side sealing material that seals the gas flow path toward the inter-lens space so as to block the gas flow path on the image side, the sealability in the inter-lens space can be maintained to effectively suppress the water vapor from entering the inter-lens space and to prevent dew condensation on the lens surface.

### BRIEF DESCRIPTION OF DRAWINGS

FIG. 1 is a schematic cross-sectional view of a lens unit according to a first embodiment of the present invention.

FIG. 2 is a schematic cross-sectional view of a camera module including the lens unit of FIG. 1.

FIG. 3 is a schematic cross-sectional view of a lens unit according to a second embodiment of the present invention.

FIG. 4 is a cross-sectional view of a main part illustrating a first modified example of an image-side sealing material of a seal portion.

FIG. 5 is a cross-sectional view of a main part illustrating a second modified example of the image-side sealing material of the seal portion.

FIG. 6 is a cross-sectional view taken along a line A-A in FIG. 5.

FIG. 7 is a cross-sectional view taken along a line B-B in FIG. 5.

FIG. 8 is a cross-sectional view of a main part illustrating a third modified example of the image-side sealing material of the seal portion.

FIG. 9 is a schematic view of a vehicle as a mobile body on which an imaging system (in-vehicle system) including a camera module according to an embodiment of the present invention is mounted.

FIG. 10 is a block diagram illustrating a configuration of an imaging apparatus constituting the imaging system in FIG. 9.

FIG. 11 is a schematic cross-sectional view illustrating an example of a conventional lens unit.

### DESCRIPTION OF EMBODIMENTS

Hereinafter, an embodiment of the present invention will be described with reference to the drawings. However, the present embodiment can realize a highly reliable system particularly in a sensing system and contributes to the development of a tough infrastructure. That is, the present embodiment targets “9. Build infrastructure, promote industry, innovation and foster resilience” from the United Nations' Sustainable Development Goals (SDGs), which states, “9.1 Develop quality, reliable, sustainable and resilient infrastructure, including regional and transborder infrastructure, to support economic development and human well-being, with a focus on affordable and equitable access for all.”

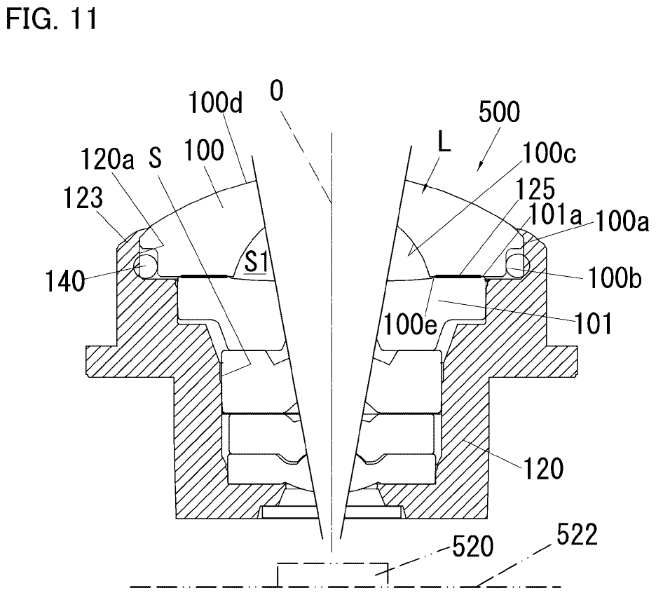

Furthermore, the lens unit of the present embodiment described below is particularly for a camera module such as an in-vehicle camera, and for example, is fixedly installed on the outer surface side of an automobile, and wiring is drawn into the automobile and connected to a display or other apparatuses. In all the drawings including FIG. 11 described above, hatching is omitted for the lens.

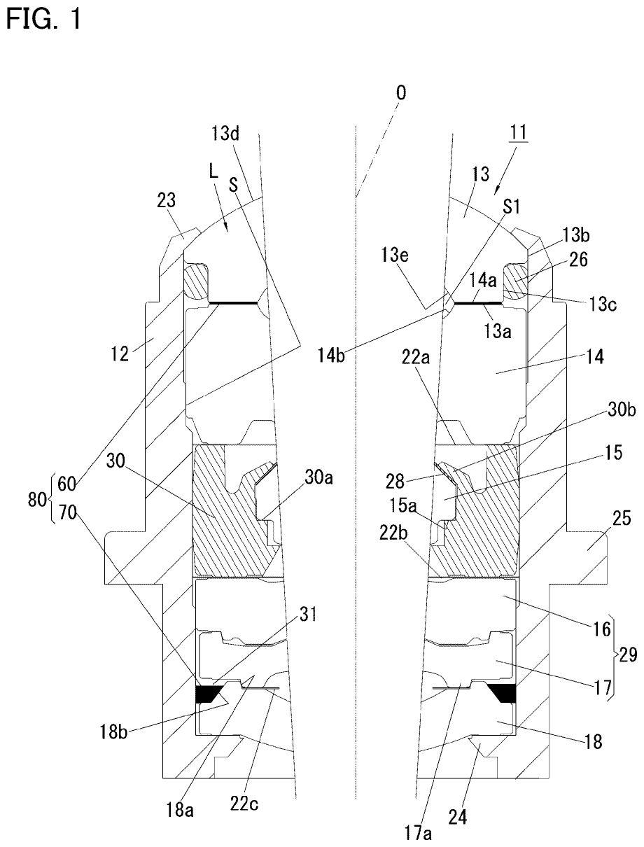

FIG. 1 illustrates a lens unit 11 according to a first embodiment of the present invention. As illustrated in the drawing, a lens unit 11 of the present embodiment includes, for example, a cylindrical lens barrel (barrel) 12 made of resin (may be made of metal), a plurality of lenses arranged in an inner accommodation space S of the lens barrel 12, for example, six lenses including a first lens 13, a second lens 14, a third lens 15, a fourth lens 16, a fifth lens 17, and a sixth lens 18 from the object side, and three diaphragm members 22a, 22b, and 22c. In this case, the first lens 13 has a concave surface 13e at the central portion of the image-side surface while the object-side surface thereof forms a convex surface 13d, and the second lens 14 adjacent to the first lens 13 on the image side has a concave surface 14b at the central portion of the object-side surface. Therefore, in the assembled state of FIG. 1 in which the first and second lenses 13 and 14 are bonded by seat surfaces 13a and 14a on the radially outer sides thereof, an inter-lens space S1 is formed between the first lens 13 and the second lens 14. In addition, the third lens 15 is held by an inner holding portion of a cylindrical resin intermediate spacer (intermediate ring) 30 interposed between the second lens 14 and the fourth lens 16, and the inner holding portion holds the third lens 15 from the image side by a step portion 30a formed on an inner peripheral surface of the intermediate spacer 30. In addition, the intermediate spacer 30 has a caulking portion 30b in an upper portion on the inner diameter side, and the caulking portion 30b is thermally caulked radially inward so as to press an image-side stepped surface 15a of the third lens 15 against the step portion 30a of the intermediate spacer 30 in the optical axis direction. Furthermore, the fourth lens 16 and the fifth lens 17 are bonded to each other to constitute a bonded lens 29, and in the fifth lens 17, an annular convex portion 17a formed on an image-side surface thereof is fitted into a concave portion 18a on an object-side surface of the sixth lens 18, and centering is performed between the lenses 16, 17, and 18. In addition, the sixth lens 18 is a meniscus lens that is easily deformed in an environment where a temperature change is severe, and thus, is loosely fitted to the inner surface of the lens barrel 12 with a predetermined gap.

Further, in the present embodiment, the diaphragm members 22a, 22b, and 22c are respectively interposed between the second lens 14 and the intermediate spacer 30, between the intermediate spacer 30 and the fourth lens 16, and between the fifth lens 17 and the sixth lens 18, and these diaphragm members 22a, 22b, and 22c are “aperture diaphragms” that limit the amount of transmitted light and determine an F value that is an index of brightness, or “light-shielding diaphragms” that shield light rays that cause ghosts and light rays that cause aberrations. An in-vehicle camera including such a lens unit 11 includes the lens unit 11, a substrate having an image sensor (not illustrated), and an installation member (not illustrated) that installs the substrate in a vehicle such as an automobile.

The plurality of lenses 13, 14, 15, 16, 17, and 18 incorporated, accommodated, and held in the inner accommodation space S of the lens barrel 12 are stacked and arranged with their optical axes aligned, and the lenses 13, 14, 15, 16, 17, and 18 are arranged along one optical axis O to constitute a group of lens groups L used for imaging. In this case, the first lens 13 located closest to the object side constituting the lens group L is a spherical glass lens, the third lens 15 held by the intermediate spacer 30 is also a spherical glass lens, and the other lenses 14, 16, 17, and 18 are resin lenses, but the present invention is not limited thereto. In addition, an antireflection film, a hydrophilic film, a water-repellent film, and the like are provided on the surfaces (the object-side surface and/or the image-side surface) of these lenses 13, 14, 15, 16, 17, and 18 as necessary. In particular, in the present embodiment, an infrared cut filter 28 is provided by vapor deposition on the object-side surface of the third lens 15 held by the intermediate spacer 30. Therefore, in the case of the present embodiment, the infrared cut filter is not provided at the image-side end of the lens barrel 12 so as to seal the inside of the inner accommodation space S to the outside (that is, the image-side end of the lens barrel 12 is not sealed to the outside). Furthermore, all of the lenses 13, 14, 15, 16, 17, and 18, the intermediate spacer (intermediate ring) 30, the infrared cut filter 28, and the diaphragms 22a, 22b, and 22c of the lens group described above are optical elements incorporated in the inner accommodation space S of the lens barrel 12 and involved in the optical characteristics of the lens unit 11.

Furthermore, in the present embodiment, an O-ring 26 as a seal member is interposed between the first lens 13 located closest to the object side and the lens barrel 12 to prevent water and dust from entering the lens group L inside the lens barrel 12. In this case, a stepped diameter-reduced portion 13c whose diameter is reduced in the image-side portion of the lens 13 is provided on the outer peripheral side surface 13b of the first lens 13, the O-ring 26 is attached to the diameter-reduced portion 13c, and the O-ring 26 is compressed in the radial direction between the outer peripheral side surface 13b of the first lens 13 and the inner peripheral surface of the lens barrel 12, whereby the object-side end of the lens barrel 12 is sealed. Furthermore, the O-ring 26 can also constitute a part of an object-side sealing material of a seal portion to be described later.

In addition, in a state where the lens group L is incorporated, accommodated, and held in the inner accommodation space S of the lens barrel 12, the caulking portion 23 of the end on the object side (the upper end in FIG. 1) is caulked radially inward, whereby the first lens 13 located closest to the object side of the lens group L is fixed to the end on the object side of the lens barrel 12 by the caulking portion 23. Furthermore, the fixation of the first lens 13 is not limited to the caulking portion 23, and may be performed by a fixing cap attached to the end on the object side of the lens barrel 12 after the lenses 13, 14, 15, 16, 17, and 18 are accommodated in the lens barrel 12.

In addition, an inner flange portion 24 having an opening portion having a diameter smaller than that of the sixth lens 18 is provided at an end (lower end in FIG. 1) on the image side of the lens barrel 12. The plurality of lenses 13, 14, 15, 16, 17, and 18 constituting the lens group L, the intermediate spacer 30, and the diaphragm members 22a, 22b, and 22c are held and fixed in the optical axis direction in the lens barrel 12 by the inner flange portion 24 and the caulking portion 23.

In addition, the lens unit 11 of the present embodiment includes a seal portion 80 for preventing water vapor from entering the inter-lens space S1 formed between the first lens 13 and the second lens 14 (particularly from the image side). In this case, the seal portion 80 forms a two-stage seal including an object-side sealing material that seals the gas flow path toward the inter-lens space S1 so as to block the gas flow path on the object side and an image-side sealing material that is located closer to the image side than the object-side sealing material in the direction along the optical axis O and seals the gas flow path toward the inter-lens space S1 so as to block the gas flow path on the image side. Specifically, the object-side sealing material of the seal portion 80 has an adhesive layer 60 that adheres annular seat surfaces 13a and 14a of the first lens 13 and the second lens 14 facing each other in the optical axis direction in an airtight state so that the inside of the inter-lens space S1 is sealed to the outside thereof. The image-side sealing material of the seal portion 80 includes an adhesive 70 interposed between the lens barrel 12 and the sixth lens 18 as an optical element located closest to the image side constituting the lens group L.

In this case, as the adhesive layer 60 for forming the object-side sealing material, it is preferable to use an olefin-based or acryl-based low moisture permeability (for example, a water vapor transmission rate of 60 g/m²·24 hr or less) adhesive having low hardness, and the thickness of the adhesive layer is preferably 5 to 20 μm. On the other hand, the adhesive 70 forming the image-side sealing material is particularly preferably an olefin-based low moisture permeability (for example, a water vapor transmission rate of 60 g/m²·24 hr or less) adhesive (for example, a UV curable adhesive), and in particular, it is preferable to use a colored adhesive (for example, white, black, milky white close to gray, and the like) other than transparent. This is because when the adhesive is transparent, light may be reflected to cause a ghost phenomenon.

In addition, the thickness of the adhesive 70 forming the image-side sealing material is preferably 5 to 1000 μm, and in this case, the adhesive 70 is filled over the entire circumference in the annular adhesive storage space 31 between the tapered surface 18b formed at the radially outer end edge of the object-side surface of the sixth lens 18 and the inner surface of the lens barrel 12 whose thickness (dimension in the optical axis direction) decreases toward the radially outer side. In addition, a gap (gas flow path) between the peripheral side surface of the sixth lens 18 and the inner surface of the lens barrel 12 or a gap (gas flow path) between the inner surface of the inner flange portion 24 and the image-side surface of the sixth lens 18 may be further filled with the adhesive 70.

Of course, the image-side sealing material is not limited to an adhesive, and may be another sealing material such as an O-ring or a moisture absorber (water absorber), and the image-side sealing material may be filled between other lenses 14, 15, 16, and 17 that can form a gas flow path toward the inside of the inter-lens space S1, between these lenses 14, 15, 16, and 17 and the lens barrel 12, or between another optical element (for example, the intermediate spacer 30) and the lens barrel 12.

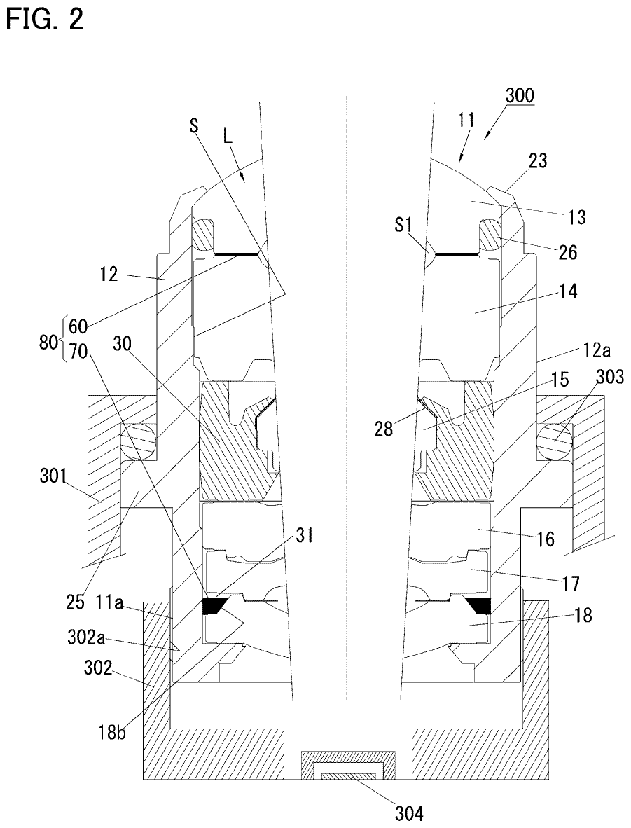

FIG. 2 is a schematic cross-sectional view of a camera module 300 of the present embodiment including the lens unit 11 having the above configuration. As illustrated in the drawing, the camera module 300 includes the lens unit 11 of FIG. 1 in which a filter 99 is attached to the image-side end.

The camera module 300 includes an upper case (camera case) 301 that is an exterior component and a mount (base) 302 that holds the lens unit 11. In addition, the camera module 300 includes a seal member 303 and a package sensor (imaging element; an image sensor) 304.

The upper case 301 is a member that is engaged with the flange portion 25 provided in a flange shape on the outer peripheral surface 12a of the lens barrel 12 and exposes the object-side end of the lens unit 11 to cover the other portion. The mount 302 is disposed inside the upper case 301 and has a female screw 302a screwed with the male screw 11a of the lens unit 11. The seal member 303 is a member interposed between the inner surface of the upper case 301 and the outer peripheral surface 12a of the lens barrel 12 of the lens unit 11, and is a member for maintaining airtightness inside the upper case 301.

The package sensor 304 is disposed inside the mount 302 and is disposed at a position where an image of an object formed by the lens unit 11 is received. In addition, the package sensor 304 has a transparent cover on the outer side, and includes a charge coupled device (CCD), a complementary metal oxide semiconductor (CMOS), or the like inside the transparent cover, and converts light collected and arriving through the lens unit 11 into an electrical signal. The converted electric signal is converted into analog data or digital data which is a component of image data captured by the camera.

As described above, according to the present embodiment, the water vapor is prevented from entering the inter-lens space S1 by the two-stage seal including the object-side sealing material (adhesive layer) 60 that seals so as to block the gas flow path toward the inside of the inter-lens space S1 on the object side and the image-side sealing material (adhesive) 70 that seals so as to block the gas flow path toward the inside of the inter-lens space S1 on the image side. Therefore, it is possible to effectively avoid a situation in which water vapor particularly from the image side, in particular, water vapor taken in the inner accommodation space S and generated in the mounting substrate of the image sensor that receives light collected through the lens unit 11 on the image side and converts the light into an electric signal, enters the inter-lens space S1, and dew condensation occurs on the concave surface 13e that is the back surface of the first lens 13. Therefore, it is possible to avoid a situation in which the captured image is blurred and desired resolution cannot be obtained (visibility is deteriorated).

As described above, when the image-side sealing material 70 is provided between the lens barrel 12 and the sixth lens 18 at the end on the image side where the entry of water vapor into the lens unit 11 is most concerned, among the gas flow path that can allow the entry of water vapor into the lens unit 11, the water vapor flowing into the inter-lens space S1 can be cut off from the root by the generation source, so that the entire inside of the inner accommodation space S of the lens barrel 12 can be kept in a low humidity state, and an excellent lens antifogging effect can be achieved for all the lenses constituting the lens group L. In addition, such a configuration is particularly advantageous in the case of the lens unit structure as in the present embodiment in which water vapor easily enters from the image side, that is, in the case where the sixth lens 18 located closest to the image side is a meniscus lens which is easily deformed in an environment where temperature changes drastically in a state where the image-side end of the lens barrel 12 is not sealed, and thus is loosely fitted to the inner surface of the lens barrel 12 with a predetermined gap.

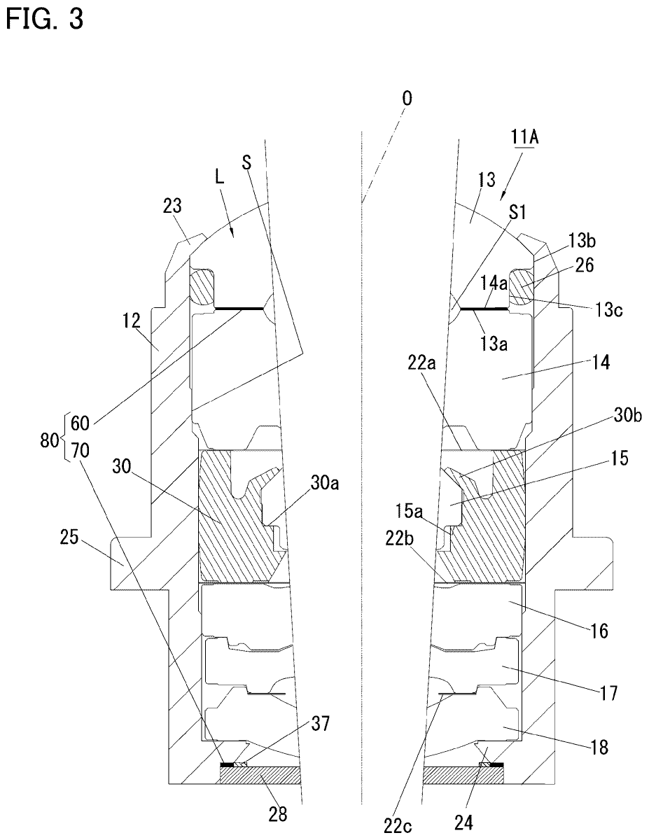

FIG. 3 illustrates a lens unit 11A according to a second embodiment of the present invention. As illustrated in the drawing, in the present embodiment, the infrared cut filter 28 is not provided on the object-side surface of the third lens 15 by vapor deposition, but instead, the infrared cut filter 28 is bonded to the image-side end of the lens barrel 12 as a blocking body (optical element) that seals the inside of the inner accommodation space S with respect to the outside on the image side. In this case, the infrared cut filter 28 is adhesively fixed to the image-side surface of the inner flange portion 24 via an adhesive 70 as an image-side sealing material of the seal portion 80. Therefore, in the present embodiment, unlike the first embodiment, an adhesive that is an image-side sealing material is not filled between the sixth lens 18 and the lens barrel 12 (Of course, it may be filled).

A water absorber 37 is also optionally provided on the object-side surface (or the image-side surface) of the infrared cut filter 28. Such a water absorber 37 may form an image-side sealing material of the seal portion 80, and may be a film body formed on the surface of the infrared cut filter 28 and having a water absorption rate of 10% or more. Such a film body is formed by, for example, a film forming method such as dip coating, spin coating, or die coating. The water absorber 37 preferably has a light shielding property and is annularly provided outside an effective diameter of the lens group. Accordingly, the water absorber 37 does not affect the optical performance of the lens unit, and an effect of suppressing ghost and flare can be obtained due to the light shielding property of the water absorber. The water absorber 37 preferably has a thickness of 0.1 to 100 μm. When the thickness dimension of the water absorber is smaller than 0.1 μm, the water absorption rate becomes insufficient, and on the other hand, when the thickness dimension of the water absorber is larger than 100 μm, the light transmittance decreases, and desired optical performance cannot be obtained. Examples of the material of the water absorber that can satisfy a desired water absorption rate and light transmittance include polyacrylate, starch-acrylate graft polymer, vinyl acetate copolymer, polyvinyl alcohol-based polymer, carboxymethyl cellulose-based polymer, hydroxypropyl cellulose, polyvinyl alcohol, polyvinyl pyrrolidone, polyvinyl acetal, polyvinyl acetate, silica gel, zeolite, and activated carbon.

Furthermore, the other configurations are the same as those of the first embodiment described above, and therefore, the same reference numerals are given and the description thereof will be omitted.

Even with such a configuration of the present embodiment, since the seal portion 80 that forms the two-stage seal on the object side and the image side is provided, it is possible to obtain the same operation and effect as those of the first embodiment.

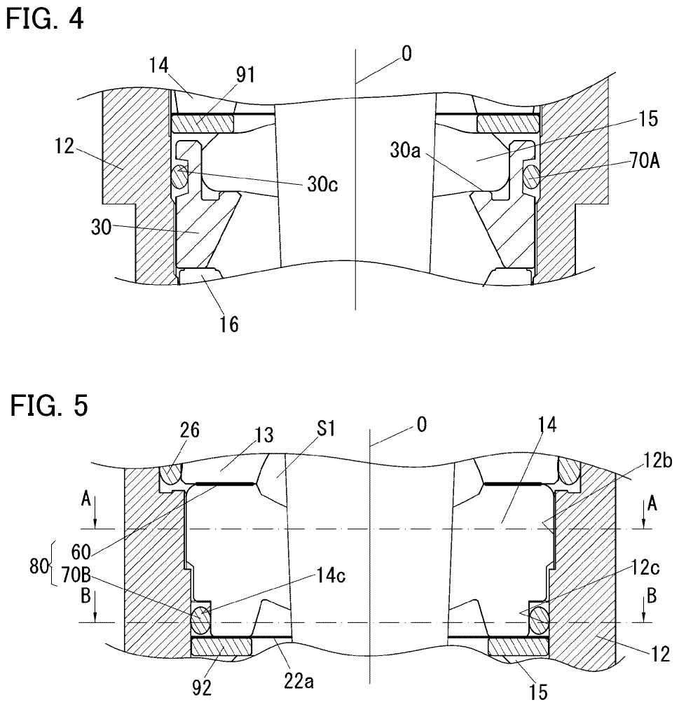

FIG. 4 illustrates a first modified example of the image-side sealing material of the seal portion 80. In this modified example, an image-side sealing material 70A is interposed as an O-ring between the intermediate spacer 30 and the lens barrel 12 instead of the image-side end of the lens unit as in the above-described embodiment, and is sealed so as to block the gas flow path toward the inter-lens space S1 on the image side. In this case, the O-ring 70A is airtightly inserted between the intermediate spacer 30 and the lens barrel 12 in a state of being wound in an annular groove 30c formed in an object-side end of an outer peripheral side surface of the intermediate spacer 30 (therefore, the shape of the third lens 15 held by the intermediate spacer 30 is also changed) whose shape is changed from that of the first embodiment. On the other hand, although not illustrated, the object-side sealing material of the seal portion 80 is formed by the adhesive layer 60 interposed between the seat surfaces 13a and 14a of the first and second lenses 13 and 14 as in the first embodiment.

Furthermore, although the same applies to the above-described embodiment, most of the intermediate spacer 30 is fitted to the position of the inner peripheral surface portion of the lens barrel 12 forming a polygon in the cross section perpendicular to the optical axis direction so as to be in point contact (or short line contact) with the inner peripheral surface of the lens barrel 12 in the circumferential direction in the cross section perpendicular to the optical axis direction. However, the annular groove 30c of the intermediate spacer 30 formed by winding the O-ring 70A faces the inner peripheral surface portion of the lens barrel 12 forming a circle in the cross section perpendicular to the optical axis direction. Therefore, the O-ring 70A is interposed in a state of being compressed in the radial direction (the compression ratio is smaller than that of the O-ring 26 at the object-side end that ensures water resistance that can withstand high-pressure cleaning) between the lens barrel inner peripheral surface portion of the circular cross section and the bottom surface of the annular groove 30 forming the circular outer peripheral surface. Furthermore, in the present modified example, an annular spacer 91 is interposed between the radially outer end of the object-side surface of the third lens 15 and the radially outer end of the image-side surface of the second lens 14.

According to the configuration of the first modified example as well, since the seal portion 80 that forms a two-stage seal on the object side and the image side is provided, it is possible to obtain the same operation and effect as those of the first embodiment, and since the intermediate spacer 30, which is an optical element other than the lens, is used as the optical element that interposes the image-side sealing material 70A with the lens barrel 12, it is not necessary to process the lens in order to interpose the image-side sealing material, so that there is no influence on the optical characteristics, which is advantageous. In addition, when the O-ring is used as the image-side sealing material 70A in this manner, mountability to the intermediate spacer 30 and mountability to the lens unit 11 are improved.

Furthermore, in another possible embodiment (not illustrated), the O-ring 70A may be interposed between the other lenses 16, 17, and 18 on the image side and the lens barrel 12.

FIG. 5 illustrates a second modified example of the image-side sealing material of the seal portion 80. In this modified example, an image-side sealing material 70B is inserted as an O-ring between the second lens 14 and the lens barrel 12 instead of the image-side end of the lens unit as in the above-described embodiment, and is sealed so as to block the gas flow path toward the inside of the inter-lens space S1 on the image side. In this case, the O-ring 70B is airtightly interposed between the second lens 14 and the lens barrel 12 in a state of being wound in an annular groove 14c formed at the end on the image side of the outer peripheral side surface of the second lens 14. On the other hand, the object-side sealing material of the seal portion 80 is formed by the adhesive layer 60 interposed between the seat surfaces 13a and 14a of the first and second lenses 13 and 14 as in the first embodiment.

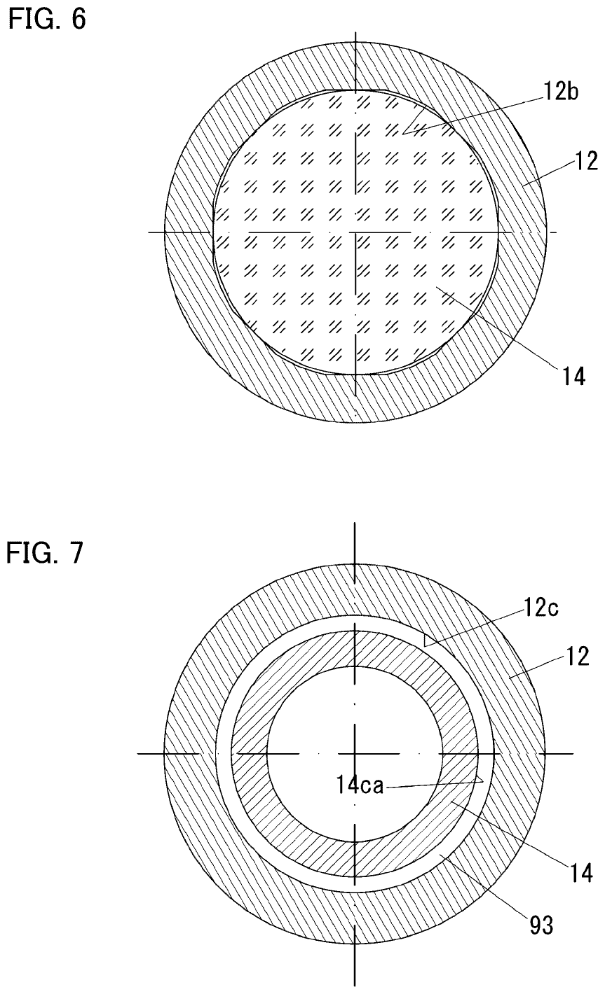

Furthermore, although the same applies to the above-described embodiment, most of the second lens 14 is fitted to the inner peripheral surface portion 12b of the lens barrel 12 forming a polygon in a cross section perpendicular to the optical axis direction so as to be in point contact (or short line contact) with the inner peripheral surface of the lens barrel 12 in the circumferential direction in a cross section perpendicular to the optical axis direction (see FIG. 6 which is a cross section taken along line A-A in FIG. 5), but the annular groove 14c of the second lens 14 formed by winding the O-ring 70B faces the inner peripheral surface portion 12c of the lens barrel 12 forming a circle in a cross section perpendicular to the optical axis direction. Therefore, the O-ring 70B is inserted in an annular space 93 (see FIG. 7 which is a cross section taken along line B-B in FIG. 5) between the lens barrel inner peripheral surface portion having the circular cross section and the bottom surface 14ca of the annular groove 14c forming the circular outer peripheral surface in a state of being compressed in the radial direction. Furthermore, in the present modified example, an annular light shielding plate 92 is interposed between the radially outer end of the object-side surface of the third lens 15 and the radially outer end of the image-side surface of the second lens 14, and the O-ring 70B described above is provided on the light shielding plate 92 with the diaphragm 22a interposed therebetween, thereby reducing the influence of a ghost.

According to the configuration of the second modified example as well, since the seal portion 80 that forms the two-stage seal on the object side and the image side is provided, it is possible to obtain the same operation and effect as those of the first embodiment.

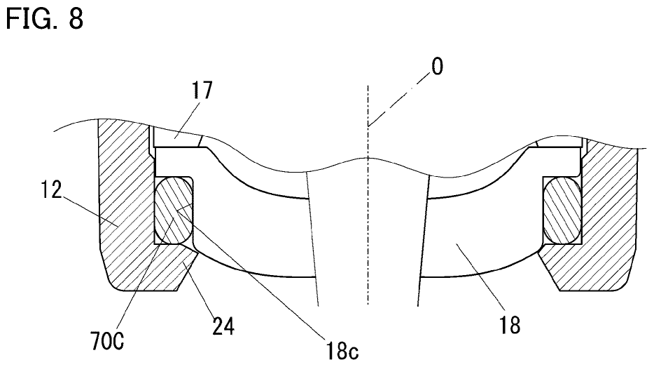

FIG. 8 illustrates a third modified example of the image-side sealing material of the seal portion 80. In this modified example, the image-side sealing material is provided between the sixth lens 18 and the lens barrel 12 as in the first embodiment described above, but is not an adhesive as described above, and is interposed as an O-ring 70C between the sixth lens 18 and the lens barrel 12, and is sealed so as to block the gas flow path toward the inside of the inter-lens space S1 on the image side. In this case, the O-ring 70C is airtightly inserted between the second lens 14 and the lens barrel 12 in a state of being placed on the inner flange portion 24 while being wound around an annular groove 18c formed at an image-side end of an outer peripheral side surface of the sixth lens 18. In addition, the O-ring 70C is preferably made of, for example, butyl rubber having low gas permeability, and is preferably colored for the reason described above in order to prevent the occurrence of a ghost phenomenon.

On the other hand, although not illustrated, the object-side sealing material of the seal portion 80 is formed by the adhesive layer 60 interposed between the seat surfaces 13a and 14a of the first and second lenses 13 and 14 as in the first embodiment.

According to the configuration of the third modified example as well, since the seal portion 80 that forms the two-stage seal on the object side and the image side is provided, it is possible to obtain the same operation and effect as those of the first embodiment.

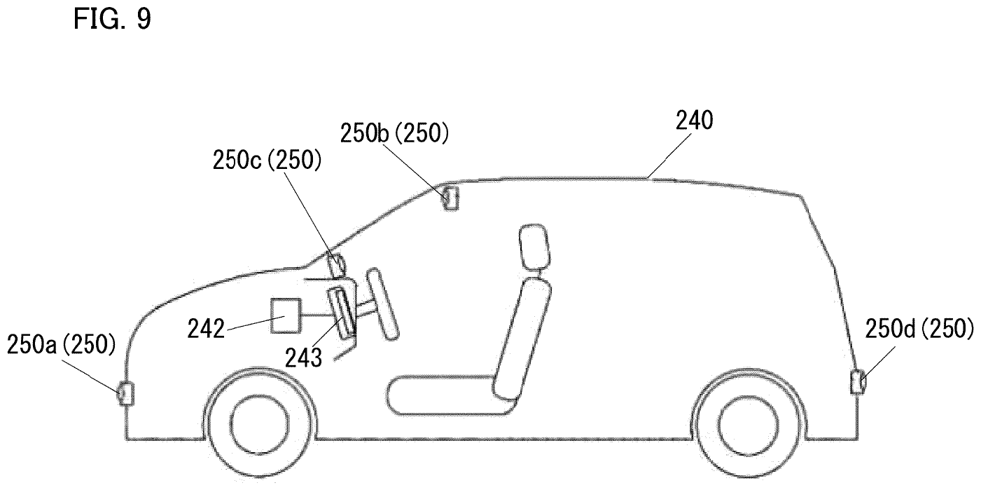

FIG. 9 schematically illustrates a vehicle 240 as a mobile body on which an in-vehicle system (imaging system) including the imaging apparatus 250 including the camera module 300 of FIG. 2 is mounted. As illustrated in the drawing, the imaging apparatus 250 can be mounted on the vehicle 240, and FIG. 9 is an arrangement example illustrating a mounting position of the imaging apparatus 250 in the vehicle 240. The imaging apparatus 250 mounted on the vehicle 240 can also be referred to as an in-vehicle camera, and can be installed at various places of the vehicle 240. For example, a first imaging apparatus 250a may be disposed at or near a front bumper as a camera for monitoring the front when vehicle 240 travels. In addition, a second imaging apparatus 250b that monitors the front may be disposed near an inner rearview mirror in the cabin of the vehicle 240. The third imaging apparatus 250c may be disposed on a dashboard, in an instrument panel, or the like as a camera for monitoring the driving situation of the driver. The fourth imaging apparatus 250d may be installed at the rear of the vehicle 240 for the rear monitor of the vehicle 240. The imaging apparatuses 250a and 250b can be referred to as front cameras. The third imaging apparatus 250c can be referred to as an in-camera. The fourth imaging apparatus 250d can be referred to as a rear camera. The imaging apparatus 250 is not limited thereto, and includes imaging apparatuses installed at various positions such as a left side camera that captures a left rear side and a right side camera that captures a right rear side.

An image signal of an image captured by the imaging apparatus 250 can be output to the information processing apparatus (controller) 242 and/or the display apparatus (output apparatus) 243 in the vehicle 240. The information processing apparatus 242 and the display apparatus 243 constitute an in-vehicle system together with the imaging apparatus 250. The information processing apparatus 242 in the vehicle 240 includes an apparatus that processes an image signal (captured image) acquired by the imaging apparatus 250, recognizes the image (recognizes an object in the captured image), and supports driving of the driver. Furthermore, the information processing apparatus 242 is configured to output the recognition information of the object in the captured image to the display apparatus 243, and includes, for example, a navigation apparatus, a collision damage reduction brake apparatus, an inter-vehicle distance control apparatus, a lane deviation warning apparatus, and the like, but is not limited thereto. The display apparatus 243 displays an image processed and output by the information processing apparatus 242, but can also directly receive an image signal from the imaging apparatus 250. In addition, the display apparatus 243 may employ a liquid crystal display (LCD), an organic electro-luminescence (EL) display, and an inorganic EL display, but is not limited thereto. The display apparatus 243 can display, to the driver, an image signal output from the imaging apparatus 250 that captures an image of a position difficult to be visually recognized by the driver, such as the rear camera (can output information to the occupant).

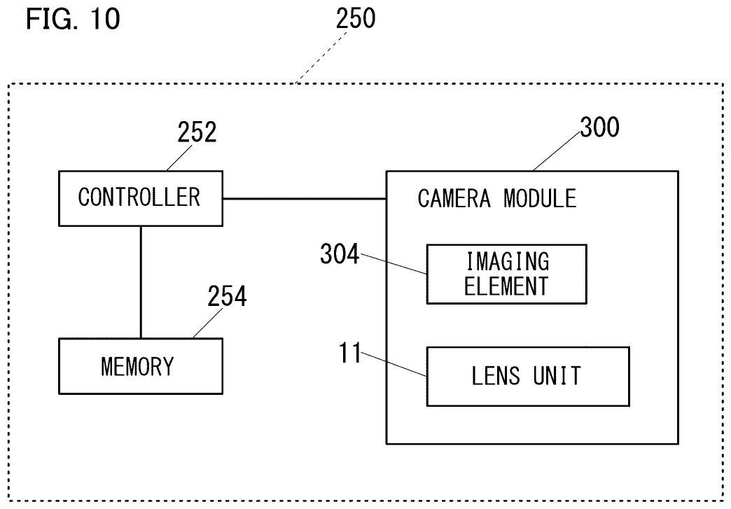

FIG. 10 illustrates a configuration of an imaging apparatus included in the in-vehicle system of FIG. 9. As illustrated in the drawing, the imaging apparatus 250 according to the embodiment includes a controller 252, a memory 254, and the camera module 300 in FIG. 2 described above.

The controller 252 controls the camera module 300 and processes an electric signal output from the imaging element 304 of the camera module 80. The controller 252 may be configured as, for example, a processor.

Furthermore, the controller 252 may include one or more processors. The processor may include a general-purpose processor that loads a specific program and executes a specific function, and a dedicated processor specialized for specific processing. The dedicated processor may include an application-specific integrated circuit (IC). The application-specific IC is also referred to as an application specific integrated circuit (ASIC). The processor may include a programmable logic device. The programmable logic device is also referred to as a programmable logic device (PLD). The PLD may include a field-programmable gate array (FPGA). The controller 252 may be either a system-on-a-chip (SoC) in which one or more processors cooperate or a system in a package (SiP). Furthermore, the controller 252 may have a function similar to that of the information processing apparatus 242 described above, and for example, may process a captured image output from the imaging element 304 and recognize an object in the captured image.

The memory 254 stores various types of information or parameters related to the operation of the imaging apparatus 250. The memory 254 may include, for example, a semiconductor memory or the like. The memory 254 may function as a work memory of the controller 252. The memory 254 may store the captured image. The memory 254 may store various parameters and the like for the controller 252 to perform detection processing based on the captured image. The memory 254 may be included in the controller 252.

As described above, the camera module 300 captures a subject image formed via the lens unit 11 by the imaging element 304, and outputs the captured image. The image captured by the camera module 300 is also referred to as a captured image.

The imaging element 304 may include, for example, a CMOS image sensor, a CCD, or the like. The imaging element 304 has an imaging surface on which a plurality of pixels is arranged. Each pixel outputs a signal specified by a current or a voltage according to the amount of incident light. The signal output from each pixel is also referred to as imaging data.

The imaging data may be read out by the camera module 300 for all the pixels and taken into the controller 252 as a captured image. The captured image read for all the pixels is also referred to as a maximum captured image. The imaging data may be read by the camera module 300 for some pixels and captured as a captured image. In other words, the imaging data may be read from pixels in a predetermined capturing range. The captured image data read from the pixels in the predetermined capturing range may be captured as a captured image. The predetermined capturing range may be set by the controller 252. The camera module 300 may acquire a predetermined capturing range from the controller 252. The imaging element 304 may capture an image in a predetermined capturing range of the subject image formed via the lens unit 11.

Furthermore, the present invention is not limited to the above-described embodiments, and various modification can be made without departing from the gist thereof. For example, in the present invention, the shape of the lens, the lens barrel, or the like, the formation form of the seal portion, and the like are not limited to the above-described embodiments. In addition, a part or all of the above-described embodiments may be combined, or a part of the configuration may be omitted from one of the above-described embodiments without departing from the gist of the present invention.

### REFERENCE SIGNS LIST

11, 11A LENS UNIT
12 LENS BARREL
13 FIRST LENS
14 SECOND LENS
28 INFRARED CUT FILTER (BLOCKING BODY)
60 ADHESIVE LAYER (OBJECT-SIDE SEALING MATERIAL)
70, 70A, 70B, 70C IMAGE-SIDE SEALING MATERIAL
80 SEAL PORTION
242 INFORMATION PROCESSING APPARATUS
243 DISPLAY APPARATUS
250 IMAGING APPARATUS
252 CONTROLLER
300 CAMERA MODULE
304 PACKAGE SENSOR (IMAGING ELEMENT)
L LENS GROUP
O OPTICAL AXIS
S INNER ACCOMMODATION SPACE
S1 INTER-LENS SPACE

1. A lens unit including an optical element having at least a lens group formed by arranging a plurality of lenses along an optical axis and a lens barrel having an inner accommodation space accommodating and holding the optical element, the lens group including a first lens located closest to an object side and a second lens adjacent to the first lens on an image side, and an inter-lens space being formed between the first lens and the second lens, the lens unit comprising:
a seal portion that prevents entry of water vapor into the inter-lens space,
wherein the seal portion forms a two-stage seal including an object-side sealing material that seals a gas flow path toward the inter-lens space so as to block the gas flow path on an object side, and an image-side sealing material that seals a gas flow path toward the inter-lens space so as to block the gas flow path on an image side.

2. The lens unit according to claim 1, wherein the object-side sealing material of the seal portion includes an adhesive layer that adheres annular seat surfaces of the first lens and the second lens facing each other in the optical axis direction in an airtight state so that the inside of the inter-lens space is sealed to an outside thereof, and the image-side sealing material of the seal portion includes an adhesive, an O-ring, or a water absorber interposed between the optical element and the lens barrel.

3. The lens unit according to claim 2, wherein the optical element is a lens located closest to an image side constituting the lens group.

4. The lens unit according to claim 3, wherein the lens located closest to the image side is a meniscus lens, and is loosely fitted to an inner surface of the lens barrel with a predetermined gap in a state where an image-side end of the lens barrel is not sealed.

5. The lens unit according to claim 2, wherein the optical element is an intermediate ring interposed between lenses constituting the lens group.

6. The lens unit according to claim 2, wherein the optical element is a blocking body that is bonded to an image-side end of the lens barrel and seals the inside of the inner accommodation space with respect to an outside on an image side.

7. The lens unit according to claim 2, wherein the object-side sealing material of the seal portion further includes an O-ring interposed between the first lens and the lens barrel.

8. A camera module comprising: the lens unit according to claim 1; and an imaging element that converts light condensed through the lens group of the lens unit into an electrical signal.

9. An in-vehicle system mounted on a vehicle, the in-vehicle system comprising:
the camera module according to claim 8; and
a controller that processes a captured image output from the imaging element of the camera module and recognizes an object in the captured image.

10. A mobile body mounted with the in-vehicle system according to claim 9 and an output apparatus outputting information to an occupant,
wherein the controller is configured to output recognition information of the object to the output apparatus.
